(19) United States
(12) Patent Application Publication
(10) Pub. No.: US 2025/0286120 A1
(43) Pub. Date: Sep. 11, 2025

(54) STABLE LFP-BASED ALL-SOLID-STATE BATTERY CELL

(71) Applicant: GM GLOBAL TECHNOLOGY OPERATIONS LLC, Detroit, MI (US)

(72) Inventors: Qili SU, Shanghai (CN); Zhe LI, Shanghai (CN); Yong LU, Shanghai (CN); Haijing LIU, Shanghai (CN); Guoyao ZHANG, Weifang City (CN); Lianqi ZHANG, Tianjin (CN)

(21) Appl. No.: 18/618,597

(22) Filed: Mar. 27, 2024

(30) Foreign Application Priority Data
Mar. 6, 2024 (CN) 202410263220.7

(51) Int. Cl. H01M 10/0562

(52) U.S. Cl. CPC H01M 10/0562; H01M 2300/008

(57) ABSTRACT

A battery cell includes C cathode electrodes each including a cathode active material layer arranged on a cathode current collector; A anode electrodes each including an anode active material layer arranged on an anode current collector; and S separators, where C, A and S are integers greater than one. Each of the S separators includes a first sublayer including a sulfide-based solid electrolyte arranged adjacent to one of the A anode electrodes, and a second sublayer including a chloride-based solid electrolyte arranged between the first sublayer and one of the C cathode electrodes.

### CROSS-REFERENCE TO RELATED APPLICATIONS

This application claims the benefit of Chinese Patent Application No. 202410263220.7, filed on Mar. 6, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to all-solid-state battery cells including lithium iron phosphate (LFP).

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes each including a cathode active material layer arranged on a cathode current collector; A anode electrodes each including an anode active material layer arranged on an anode current collector; and S separators, where C, A and S are integers greater than one. Each of the S separators includes a first sublayer including a sulfide-based solid electrolyte arranged adjacent to one of the A anode electrodes; and a second sublayer including a chloride-based solid electrolyte arranged between the first sublayer and one of the C cathode electrodes.

In other features, the cathode active material layer comprises LFP cathode active material in a range from 30 to 98 wt % and the chloride-based solid electrolyte in a range from 0.5 to 50 wt %. The cathode active material layer further comprises at least one of a conductive additive selected from a group consisting of carbon black, graphite, graphene, graphene oxide, Super P, acetylene black, carbon nanofibers, and carbon nanotubes; and a binder selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

In other features, the first sublayer has a thickness in a range from 5 to 100 μm and the second sublayer has a thickness in a range from 2 to 50 μm. The second sublayer comprises 5 to 30 wt % and the first sublayer comprises 70 to 95 wt % of each of the S separators.

In other features, the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, Li₃ZrCl₆, and combinations thereof. The sulfide-based solid electrolyte is selected from a group consisting of pseudobinary sulfide, pseudoternary sulfide, pseudoquaternary sulfide, and combinations thereof. The first sublayer includes the sulfide-based solid electrolyte comprising 95 to 99.9 wt % and a binder comprising 0.1 to 5 wt %. The second sublayer includes the chloride-based solid electrolyte comprising 95 to 99.9 wt % and a binder comprising 0.1 to 5 wt %.

In other features, the anode active material layer of each of the A anode electrodes includes anode active material comprising 30 to 100 wt %. The anode active material layer of each of the A anode electrodes further comprises at least one of the sulfide-based solid electrolyte comprising 1 to 50 wt %; a conductive additive comprising 1 to 30 wt %; and a binder comprising 1 to 20 wt %.

In other features, the anode active material layer includes anode active material selected from a group consisting of carbonaceous material, a metal oxide, Li₄Ti₅O₁₂, a Li alloy-type material, and combinations thereof.

A battery cell includes C cathode electrodes each including a cathode active material layer arranged on a cathode current collector; A anode electrodes each including an anode active material layer arranged on an anode current collector; and S separators, where C, A and S are integers greater than one. Each of the S separators includes a first sublayer including sulfide-based solid electrolyte arranged adjacent to one of the A anode electrodes, wherein the sulfide-based solid electrolyte is selected from a group consisting of pseudobinary sulfide, pseudoternary sulfide, pseudoquaternary sulfide, and combinations thereof; and a second sublayer including chloride-based solid electrolyte arranged adjacent to one of the C cathode electrodes, wherein the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, and combinations thereof.

In other features, the cathode active material layer comprises LFP cathode active material in a range from 30 to 98 wt % and the chloride-based solid electrolyte in a range from 0.5 to 50 wt %. The cathode active material layer further comprises at least one of a conductive additive selected from a group consisting of carbon black, graphite, graphene, graphene oxide, Super P, acetylene black, carbon nanofibers, and carbon nanotubes; and a binder selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

In other features, the first sublayer has a thickness in a range from 5 to 100 μm and the second sublayer has a thickness in a range from 2 to 50 μm. The first sublayer comprises 70 to 95 wt % and the second sublayer comprises 5 to 30 wt % of each of the S separators. The first sublayer includes the sulfide-based solid electrolyte comprising 95 to 99.9 wt % and a binder comprising 0.1 to 5 wt %, and the second sublayer includes the chloride-based solid electrolyte comprising 95 to 99.9 wt % and a binder comprising 0.1 to 5 wt %.

A separator layer for a battery cell includes a first sublayer including a sulfide-based solid electrolyte The sulfide-based solid electrolyte is selected from a group consisting of pseudobinary sulfide, pseudoternary sulfide, pseudoquaternary sulfide, and combinations thereof. The separator layer includes a second sublayer including a chloride-based solid electrolyte. The chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, Li₂ZrCl₆, and combinations thereof.

In other features, the first sublayer includes the sulfide-based solid electrolyte comprising 95 to 99.9 wt % and a binder comprising 0.1 to 5 wt %, the second sublayer includes the chloride-based solid electrolyte comprising 95 to 99.9 wt % and a binder comprising 0.1 to 5 wt %, and the binder is selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including cathode electrodes, anode electrodes, and separators according to the present disclosure;

FIG. 2 is a more detailed side cross section of an example of a cathode electrode, anode electrode, and separator according to the present disclosure;

FIG. 3 is a side cross section of an example of a separator according to the present disclosure;

FIG. 4 is a graph of an example of linear scanning voltage (LSV) illustrating a stability window for chloride-based solid electrolyte (e.g., Li₃ZrCl₆);

FIG. 5 is a graph illustrating an example of kinetic stabilization of sulfide solid electrolyte at the anode electrode side;

FIG. 6A is a flowchart of an example of a method for manufacturing a first sublayer of the separator including sulfide-based solid electrolyte according to the present disclosure;

FIG. 6B is a flowchart of an example of a method for manufacturing a second sublayer of the separator including chloride-based solid electrolyte according to the present disclosure;

FIG. 7 is a flowchart of an example of a method for forming the separator according to the present disclosure;

FIG. 8 is a side cross section of an example of a bipolar battery cell according to the present disclosure; and

FIG. 9 is a graph illustrating an example of discharge capacity and coulombic efficiency percentage as a function of cycle number for LFP/graphite-based battery cells with sulfide solid electrolyte, chloride solid electrolyte, and bi-layer sulfide/chloride solid electrolyte, respectively, according to the present disclosure.

In the drawings, reference numbers may be reused to identify similar and/or identical elements.

### DETAILED DESCRIPTION

While the present disclosure described battery cells in the context of electric vehicles, the battery cells can be used in other applications.

Traditional low-cost lithium iron phosphate (LFP) cathode active materials are normally coated with carbon to enhance electronic conductivity. However, LFP has poor electrochemical compatibility with most commonly-used sulfidic electrolytes (e.g., Li₆PS₅Cl). The sulfide/LFP interfacial resistance increases dramatically within a relatively low number of cycles (e.g., 100).

A high-performance all-solid-state battery according to the present disclosure includes cathode electrodes with lithium iron phosphate (LFP) as the cathode active material. The cathode active material layer includes LFP cathode active material and a chloride-based solid electrolyte. The separators include a first sublayer including a sulfide-based solid electrolyte (arranged next to the anode electrode) and a second sublayer including a chloride-based solid electrolyte (arranged next to the cathode electrode).

The chloride-based solid electrolyte of the separator inhibits direct contact between the LFP and the sulfide solid electrolyte. Benefiting from favorable particle-to-particle and layer-to-layer interface, the LFP-based ASSB cell with enhanced interfacial compatibility delivers stable cell cycling (e.g., >400 cycles with 89% capacity retention).

The LFP active material is blended with a chloride-based solid electrolyte to obtain a cathode layer with a favorable micro-level particle-to-particle interface. The dual-electrolyte separator membrane prevents direct contact between LFP and sulfide solid electrolyte, which will enable a favorable macro-level layer-to-layer interface.

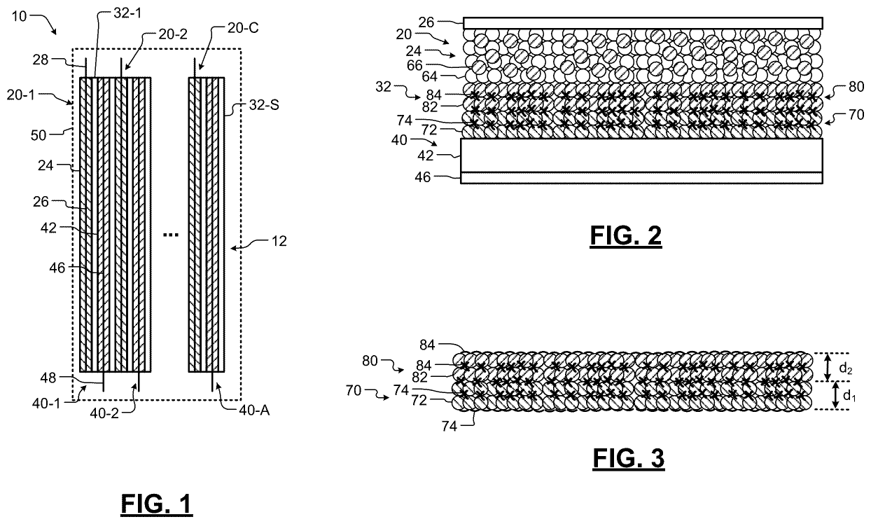

Referring now to FIG. 1, an all-solid-state battery cell 10 includes C cathode electrodes 20, A anode electrodes 40, and S separators 32-1, . . . , 32-S arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46.

During charging/discharging, the A anode electrodes 40 and the C cathode electrodes 20 exchange lithium ions. In some examples, the cathode active material layers 24 and/or the anode active material layers 42 comprise coatings including one or more active materials, one or more conductive additives, and/or one or more binder materials that are applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2 and 3, a battery cell includes a bilayer separator including both chloride-based solid electrolyte and sulfide-based solid electrolyte. In FIG. 2, the cathode active material layer 24 of the C cathode electrodes 20 includes a cathode active material 64 and a chloride-based solid electrolyte 66. The S separators 32 include a first sublayer 70 and a second sublayer 80. The first sublayer 70 includes a sulfide-based solid electrolyte 72 and a binder 74 arranged adjacent to one of the A anode electrodes 40. The second sublayer 80 includes a chloride-based solid electrolyte 82 and a binder 84 and is located between the first sublayer 70 and one of the C cathode electrodes 20.

In some examples, the cathode active material layer 24 comprises LFP cathode active material in a range from 30 to 98 wt %, chloride-based electrolyte in a range from 0.5 to 50 wt %, optional conductive additive in a range from 1 to 30 wt %, and optional binder in a range from 1 to 20 wt %. In some examples, the cathode electrode has a thickness in a range from 10 to 500 μm (e.g., 40 μm). In some examples, particles of the cathode active material are coated with carbon.

In some examples, the conductive additive in the cathode active material layer 24 is selected from a group consisting of carbon black, graphite, graphene, graphene oxide, Super P, acetylene black, carbon nanofibers, and carbon nanotubes.

In some examples, the binder in the cathode active material layer 24 is selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

In FIG. 3, the separator has a thickness in a range from 7 to 150 μm. The first sublayer 70 has a thickness d₁ and the second sublayer has a thickness d₂. In some examples, the first sublayer 70 has a thickness d₁ in a range from 5 to 100 μm. In some examples, the second sublayer 80 has a thickness d₂ in a range from 2 to 50 μm.

In some examples, the S separators 32 comprise the first sublayer 70 (sulfide-based) (70 to 95 wt %) and the second sublayer 80 (chloride-based) (5 to 30 wt % (e.g., 82.2 wt %/17.8 wt %)). In some examples, the first sublayer 70 includes sulfide solid electrolyte (95 to 99.9 wt %) and binder (0.1 to 5 wt %). The first sublayer 70 provides high Li-ion conduction (>10⁻³ Siem). The first sublayer 70 builds up a stable and passivating anode/electrolyte macro interface. In some examples, the binder 74 is a fibrillating binder such as PTFE that forms fibrils when sheared. The fibrils adhere particles together to form a film.

In some examples, the sulfide-based solid electrolyte is selected from a group consisting of pseudobinary sulfide, pseudoternary sulfide, pseudoquaternary sulfide, and combinations thereof. Examples of pseudobinary sulfide include Li₂S—P₂S₅ system (Li₅PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X═F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}AS_{0.166}S₄), Li₂S—P₂S₅—Al₂S₃ system, Li₂S—LiX—SiS₂ (X═F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

In some examples, the second sublayer 80 includes a chloride-based solid electrolyte (95 to 99.9 wt %) and a binder (0.1 to 5 wt %). The second sublayer 80 builds up favorable lithium-ion transport and has high oxidative stability and mechanical deformability. In some examples, the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, Li₂ZrCl₆, and combinations thereof.

In some examples, the anode active material layer 42 includes anode active material comprising 30 to 100 wt %, an optional sulfide solid electrolyte comprising 1 to 50 wt %, an optional conductive additive comprising 1 to 30 wt %, and an optional binder comprising 1 to 20 wt %. In some examples, a thickness of the A anode electrodes 40 is in a range from 10 to 500 μm (e.g., 20 μm).

In some examples, the anode active material in the anode active material layer 42 comprises carbonaceous material (e.g., graphite, hard carbon, soft carbon,), metal oxide/sulfide (e.g., TiO₂, FeS), Li₄Ti₅O₁₂, Li alloy-type material (e.g., silicon, transition-metal (e.g., Sn, In)), and combinations thereof. In some examples, the conductive additive is selected from a group consisting of carbon black, graphite, graphene, graphene oxide, Super P, acetylene black, carbon nanofibers, and carbon nanotubes.

In some examples, the binder in the anode active material layer 42 is selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

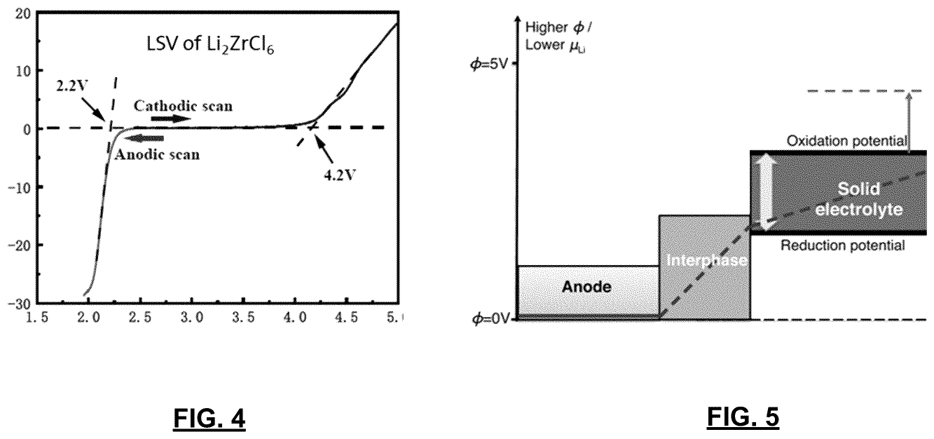

Referring now to FIGS. 4 and 5, within the ASSB cell, the second sublayer 80 (chloride-based solid electrolyte) shows a high oxidation stability toward the LFP-based cathode electrode. The first sublayer 70 (sulfidic solid electrolyte) facilitates a stable and passivating anode interface with high lithium-ion conduction.

In FIG. 4, the intrinsic stability windows of chloride-based electrolyte (e.g., Li₂ZrCl₆) is beyond the operating voltage of LFP, which makes the dual-electrolyte membrane work well on the cathode electrode side. In FIG. 5, the kinetic stabilization of sulfide solid electrolyte (e.g., Li_{9.54}Si_{1.74}P_{1.4}S_{11.7}Cl_{0.3} (LiSiPSCl)) at the anode electrode side helps the dual-electrolyte membrane form a passivating interface and protect the solid electrolyte from further decomposition. See e.g., ACS Appl. Mater. Interfaces 2015, 7, 23685 to 23693.

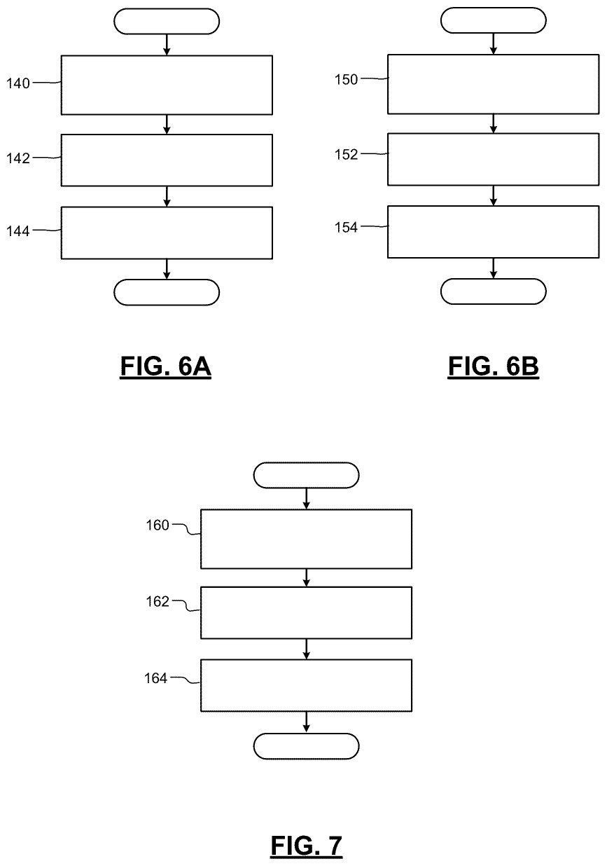

Referring now to FIGS. 6A to 7, methods for manufacturing of one of the S separators 32 is shown. In FIG. 6A, a first membrane (corresponding to the first sublayer 70) is manufactured by providing a sulfide-based solid electrolyte and a binder at 140. At 142, the sulfide-based solid electrolyte and the binder are mixed and sheared. At 144, the first membrane is formed by pressing the sulfide-based solid electrolyte and the binder using a roller with a gap G1.

In FIG. 6B, a second membrane (corresponding to the second sublayer 80) is manufactured by providing a chloride-based solid electrolyte and a binder at 150. At 152, the chloride-based solid electrolyte and the binder are mixed and sheared. At 154, the second membrane is formed by pressing the chloride-based solid electrolyte and the binder using a roller with a gap G2.

In some examples, the first sublayer 70 and the second sublayer 80 are attached and rolled. In other examples, in order to achieve a uniform and thin dual electrolyte membrane, multiple calendaring steps with target gap and temperature are used. In FIG. 7, the first membrane and the second membrane are stacked at 160. At 162, the first membrane and the second membrane are pressed and heated using a roller with a gap G3. At 164, the first membrane and the second membrane are pressed and heated using a roller with a gap G4. In some examples, G3<G1, G3<G2, and G4<G3.

In some examples, the multi-step calendaring process described above uses a decreasing roller gap to reduce a thickness of the membrane gradually and maintain separation of the LFP and sulfide solid electrolyte. In some examples, the rollers are heated to a temperature in a range from 25 to 320° C. In some examples, the rollers are heated to a temperature in a range from 80 to 150° C.

The free-standing dual-electrolyte membrane is fabricated through a solvent-free dry-film process, which eliminates the employment of volatile and toxic organic solvents and simplifies the film fabrication process by removing drying step. The approach circumvents the solvent influence on the Li-ion conduction of SE and ensure a high Li-ion conduction of dual-layer electrolyte.

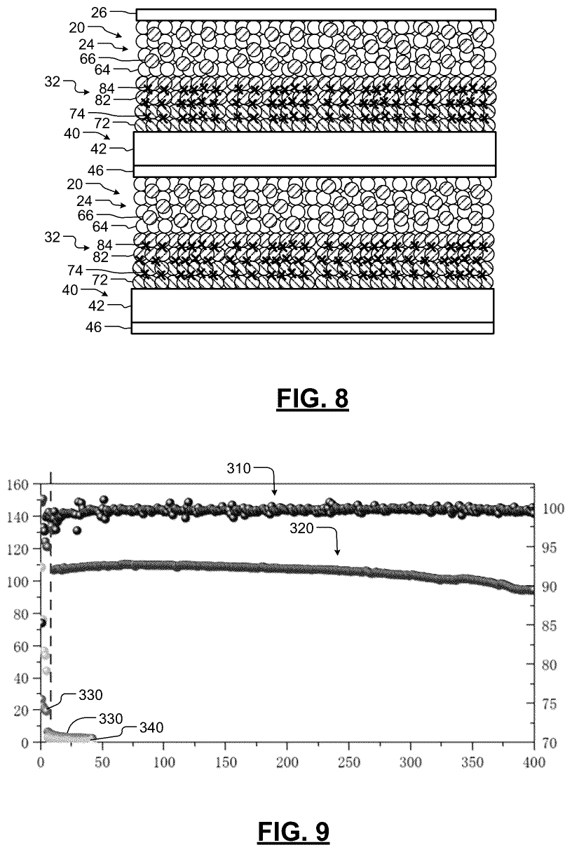

Referring now to FIG. 8, the battery cell can be arranged in a monopolar arrangement as shown in FIG. 2 or a bipolar arrangement as shown in FIG. 8.

Referring now to FIG. 9, performance of the LFP ASSB with the dual layer membrane is compared to the same battery cell using either all chloride-based solid electrolyte (e.g., LiSiPSCl) at 340 or all sulfide-based solid electrolyte (e.g., Li₂ZrCl₆) at 330. Operation is shown at 50° C. and 1C for a voltage range from 1.9V to 3.4V. As can be seen, the LFP ASSB with the dual layer membrane shows excellent coulombic efficiency (close to 100%) at 310 and stable discharge capacity cycling (89% after 400 cycles) at 320. The all chloride-based solid electrolyte (e.g., LiSiPSCl) at 340 or all sulfide-based solid electrolyte (e.g., Li₂ZrCl₆) at 330 fail before 50 cycles due to significant impedance increases.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes each including a cathode active material layer arranged on a cathode current collector;
A anode electrodes each including an anode active material layer arranged on an anode current collector; and
S separators, where C, A and S are integers greater than one,
wherein each of the S separators includes:
a first sublayer including a sulfide-based solid electrolyte arranged adjacent to one of the A anode electrodes; and
a second sublayer including a chloride-based solid electrolyte arranged between the first sublayer and one of the C cathode electrodes.

2. The battery cell of claim 1, wherein the cathode active material layer comprises LFP cathode active material in a range from 30 to 98 wt % and the chloride-based solid electrolyte in a range from 0.5 to 50 wt %.

3. The battery cell of claim 2, wherein the cathode active material layer further comprises at least one of:
a conductive additive selected from a group consisting of carbon black, graphite, graphene, graphene oxide, Super P, acetylene black, carbon nanofibers, and carbon nanotubes; and
a binder selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

4. The battery cell of claim 1, wherein the first sublayer has a thickness in a range from 5 to 100 μm and the second sublayer has a thickness in a range from 2 to 50 μm.

5. The battery cell of claim 1, wherein the second sublayer comprises 5 to 30 wt % and the first sublayer comprises 70 to 95 wt % of each of the S separators.

6. The battery cell of claim 1, wherein the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, Li₂ZrCl₆, and combinations thereof.

7. The battery cell of claim 1, wherein the sulfide-based solid electrolyte is selected from a group consisting of pseudobinary sulfide, pseudoternary sulfide, pseudoquaternary sulfide, and combinations thereof.

8. The battery cell of claim 1, wherein the first sublayer includes the sulfide-based solid electrolyte comprising 95 to 99.9 wt % and a binder comprising 0.1 to 5 wt %.

9. The battery cell of claim 1, wherein the second sublayer includes the chloride-based solid electrolyte comprising 95 to 99.9 wt % and a binder comprising 0.1 to 5 wt %.

10. The battery cell of claim 1, wherein the anode active material layer of each of the A anode electrodes includes anode active material comprising 30 to 100 wt %.

11. The battery cell of claim 10, wherein the anode active material layer of each of the A anode electrodes further comprises at least one of:
the sulfide-based solid electrolyte comprising 1 to 50 wt %;
a conductive additive comprising 1 to 30 wt %; and
a binder comprising 1 to 20 wt %.

12. The battery cell of claim 1, wherein the anode active material layer includes anode active material selected from a group consisting of carbonaceous material, a metal oxide, Li₄Ti₅O₁₂, a Li alloy-type material, and combinations thereof.

13. A battery cell comprising:
C cathode electrodes each including a cathode active material layer arranged on a cathode current collector;
A anode electrodes each including an anode active material layer arranged on an anode current collector; and
S separators, where C, A and S are integers greater than one,
wherein each of the S separators includes:
a first sublayer including sulfide-based solid electrolyte arranged adjacent to one of the A anode electrodes, wherein the sulfide-based solid electrolyte is selected from a group consisting of pseudobinary sulfide, pseudoternary sulfide, pseudoquaternary sulfide, and combinations thereof; and
a second sublayer including chloride-based solid electrolyte arranged adjacent to one of the C cathode electrodes, wherein the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, and combinations thereof.

14. The battery cell of claim 13, wherein the cathode active material layer comprises LFP cathode active material in a range from 30 to 98 wt % and the chloride-based solid electrolyte in a range from 0.5 to 50 wt %.

15. The battery cell of claim 14, wherein the cathode active material layer further comprises at least one of:
a conductive additive selected from a group consisting of carbon black, graphite, graphene, graphene oxide, Super P, acetylene black, carbon nanofibers, and carbon nanotubes; and
a binder selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).

16. The battery cell of claim 13, wherein the first sublayer has a thickness in a range from 5 to 100 μm and the second sublayer has a thickness in a range from 2 to 50 μm.

17. The battery cell of claim 13, wherein the first sublayer comprises 70 wt % to 95 wt % and the second sublayer comprises 5 to 30 wt % of each of the S separators.

18. The battery cell of claim 13, wherein:
the first sublayer includes the sulfide-based solid electrolyte comprising 95 to 99.9 wt % and a binder comprising 0.1 to 5 wt %, and
the second sublayer includes the chloride-based solid electrolyte comprising 95 to 99.9 wt % and a binder comprising 0.1 to 5 wt %.

19. A separator layer for a battery cell, comprising:
a first sublayer including a sulfide-based solid electrolyte,
wherein the sulfide-based solid electrolyte is selected from a group consisting of pseudobinary sulfide, pseudoternary sulfide, pseudoquaternary sulfide, and combinations thereof; and
a second sublayer including a chloride-based solid electrolyte,
wherein the chloride-based solid electrolyte is selected from a group consisting of Li₃YCl₆, Li₃InCl₆, Li₃YBr₆, LiI, Li₂CdCl₄, Li₂MgCl₄, Li₂Cdl₄, Li₂ZnI₄, Li₃OCl, Li₂ZrCl₆, and combinations thereof.

20. The separator layer of claim 19, wherein:
the first sublayer includes the sulfide-based solid electrolyte comprising 95 to 99.9 wt % and a binder comprising 0.1 to 5 wt %,
the second sublayer includes the chloride-based solid electrolyte comprising 95 to 99.9 wt % and a binder comprising 0.1 to 5 wt %, and
the binder is selected from a group consisting of polytetrafluoroethylene (PTFE), sodium carboxymethyl cellulose (CMC), styrene-butadiene rubber (SBR), poly (vinylidene fluoride) (PVDF), nitrile butadiene rubber (NBR), styrene ethylene butylene styrene, copolymer (SEBS), and styrene butadiene styrene copolymer (SBS).
